(19) United States
(12) Patent Application Publication
(10) Pub. No.: US 2012/0180084 A1
(43) Pub. Date: Jul. 12, 2012

(54) Method and Apparatus for Video Insertion

(75) Inventors: Yu Huang, Bridgewater, NJ (US); Qiang Hao, Morgantown, WV (US); Hong Heather Yu, West Windsor, NJ (US)

(73) Assignee: FUTUREWEI TECHNOLOGIES, INC., Plano, TX (US)

(21) Appl. No.: 13/340,883

(22) Filed: Dec. 30, 2011

Related U.S. Application Data
(60) Provisional application No. 61/432,051, filed on Jan. 12, 2011.

(51) Int. Cl. H04N 7/00

(52) U.S. Cl. 725/32

(57) ABSTRACT

An embodiment of a system and method that inserts a virtual image into a sequence of video frames. The method includes capturing geometric characteristics of the sequence of video frames, employing the captured geometric characteristics to define an area of the video frames for insertion of a virtual image, registering a video camera to the captured geometric characteristics, identifying features in the sequence of video frames to identify the defined area of video frames for insertion of the virtual image, and inserting the virtual image in the defined area. Vanishing points are estimated to determine the geometric characteristics, and the virtual image is blended with the area of video frames prior to inserting the virtual image in the defined area.

This application claims the benefit of U.S. Provisional Application No. 61/432,051, filed on Jan. 12, 2011, entitled “Method and Apparatus for Video Insertion,” which application is hereby incorporated herein by reference.

### TECHNICAL FIELD

The present invention relates to image processing, and, in particular embodiments, to a method and apparatus for video registration.

### BACKGROUND

Augmented reality (“AR”) is a term for a live direct or indirect view of a physical real-world environment whose elements are augmented by virtual computer-generated sensory input such as sound or graphics. It is related to a more general concept called mediated reality in which a view of reality is modified (possibly even diminished rather than augmented) by a computer. As a result, the technology functions to enhance one's current perception of reality.

In the case of augmented reality, the augmentation is conventionally performed in real-time and in semantic context with environmental elements, such as sports scores on TV during a match. With the help of advanced AR technology (e.g., adding computer vision and object recognition) the information about the surrounding real world of the user becomes interactive and digitally usable. Artificial information about the environment and the objects in it can be stored and retrieved as an information layer on top of the real world view.

Augmented reality research explores the application of computer-generated imagery in live-video streams as a way to expand the real-world. Advanced research includes use of head-mounted displays and virtual retinal displays for visualization purposes, and construction of controlled environments containing any number of sensors and actuators.

Present techniques to insert an image in a live video sequence exhibit numerous limitations that are visible to a viewer with a high-performance monitor. Challenging issues are how to insert control contextually relevant ads or other commercialized data in a less intrusive manner, in a desired position on the screen at a desired or appropriated time, and with an attractive desired representation in the videos.

### SUMMARY OF THE INVENTION

The above noted deficiencies and other problems of the prior art are generally solved or circumvented, and technical advantages are generally achieved, by example embodiments of the present invention, which provide a systems, methods and apparatuses that insert a virtual image into a defined area in a sequence of video frames is provided. For example, embodiment provide an apparatus includes a processing system configured to capture geometric characteristics of the sequence of video frames, employ the captured geometric characteristics to define an area of the video frames for insertion of the virtual image, register a video camera to the captured geometric characteristics, identify features in the sequence of video frames to identify the defined area of video frames for insertion of the virtual image, and insert the virtual image in the defined area.

In accordance with a further example embodiment, a method of inserting a virtual image into a defined area in a sequence of video frames is provided. The method includes capturing geometric characteristics of the sequence of video frames, employing the captured geometric characteristics to define an area of the video frames for insertion of the virtual image, registering a video camera to the captured geometric characteristics, identifying features in the sequence of video frames to identify the defined area of video frames for insertion of the virtual image, and inserting the virtual image in the defined area.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understand that these drawings depict only typical embodiments of the invention and are not therefore to be considered to be limiting of its scope. For a more complete understanding of the present invention, and the advantages thereof, reference is now made to the following descriptions taken in conjunction with the accompanying drawing, in which:

FIG. 1 provides a flow chart of a system for automatic insertion of an ad in a video stream, in accordance with an embodiment;

FIG. 2 provides a flowchart of a soccer goalmouth virtual content insertion system, in accordance with an embodiment;

FIG. 3 illustrates a goalmouth extraction procedure, in accordance with an embodiment;

FIG. 4 illustrates intersection points between horizontal and vertical lines, in accordance with an embodiment;

FIG. 5 illustrates ten lines corresponding to an image and a corresponding tennis court model, in accordance with an embodiment;

FIG. 6 provides a flowchart of the tennis court insertion system, in accordance with an embodiment;

FIG. 7 illustrates sorting of vertical lines from left to right to produce an ordered set, in accordance with an embodiment;

FIG. 8 provides a flowchart of ad insertion in a building façade system, in accordance with an embodiment;

FIG. 9 provides a flowchart for detecting vanishing points associated with a building façade, in accordance with an embodiment;

FIG. 10 illustrates estimation of a constrained line, in accordance with an embodiment; and

FIG. 11 provides a block diagram of an example system that can be used to implement embodiments of the invention.

Please note, corresponding numerals and symbols in the different figures generally refer to corresponding parts unless otherwise indicated, and may not necessarily be described again in the interest of brevity.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts The specific embodiments discussed are merely illustrative of specific ways to make and use the invention, and do not limit the scope of the invention.

Augmented reality is getting closer to real-world consumer applications. The user expects the augmented content for better comprehension and enjoyment of a real scene, such as sightseeing, sports games, and the workplace. One of its applications is video or ads insertion, also being a category of virtual content insertion. The basic concept entails identifying specific places in a real scene, tracking them, and augmenting the scene with the virtual ads. Specific region detection relies on scene analysis. For some typical videos, like sports games (soccer, tennis, baseball, volleyball, etc.), a playfield constrains the player's action region and also makes a good place for insertion of an advertisement easier to find. Playfield modeling is applied to extract the court area, and a standard model for court size is used to detect a specific region, like a soccer center circle and a goalmouth, a tennis or a volleyball court, etc.

For a building view, the façade can be appropriate to post ads. A modern building shows structured visual elements, such as parallel straight lines and repeated window patterns. Accordingly, vanishing points are estimated to determine the orientation of the architecture. Then the rectangular region from two groups of parallel lines is used for insertion of advertisements. Camera calibration is important to identify the camera parameters when the scene is captured. Based on that, a virtual ad image is transformed to the detected region for insertion with perspective projection.

Registration is employed to accurately align a virtual ad with the real scene by visual tracking. A visual tracking method can be either feature-based or region-based, as extensively discussed in the computer vision field. Sometimes global positioning system (“GPS”) data or information from other sensors (inertial data for the camera) can be used to make tracking much more robust. A failure in tracking may cause jittering and drifting which produces a bad viewing impression for users. The virtual-real blending may take into account a difference in contrast, color, and resolution to make the insertion seamless for the viewers. Apparently, it is easier to adapt the virtual ads to the real scene.

In one aspect, an embodiment relates to insertion of an advertisement in consecutive frames of a video content by scene analysis for augmented reality.

Ads can be inserted with consideration of when and where to insert, and how to appeal to viewers so that they are not disturbed. For soccer videos, ad insertion is discussed for the center circle and the goalmouth; however, stability of insertion is often not paid sufficient attention since camera motion is apparent in these scenes. In a tennis video, a court region is detected to insert ads by modeling fitting and tracking. In the tracking process, white pixels are extracted to match a model. For a building façade, a semi-autonomous interactive method is developed to insert ads or pictures on photos. The appropriate location to insert ads is not easy to detect. Registration is employed to make a virtual ad look real in a street-view video.

Embodiments provide an automatic advertisement insertion system in consecutive frames of a video by scene analysis for augmented reality. The system starts from analyzing frame-by-frame specific regions, such as a soccer goalmouth, a tennis court, or a building facade. Camera calibration parameters are obtained by extracting parallel lines corresponding to vertical and horizontal directions in the real world. Then the region appropriate to insert virtual content is warped to the front view, and the ad is inserted and blended with the real scene. Finally, the blended region is warped back into the original view. After that, following frames are processed in a similar way except applying a tracking technique between neighboring frames.

Embodiments of three typical ad insertion systems in a specific region are respectively discussed herein, i.e., above the goalmouth bar in a soccer video, on the playing court in a tennis video, and on a building façade in a street video.

Augmented reality blends virtual objects into real scenes in real time. Ad insertion is an AR application. The challenging issues are how to insert contextually relevant ads (what) less intrusively at the right place (where) and at the right time (when) with an attractive representation (how) in the videos.

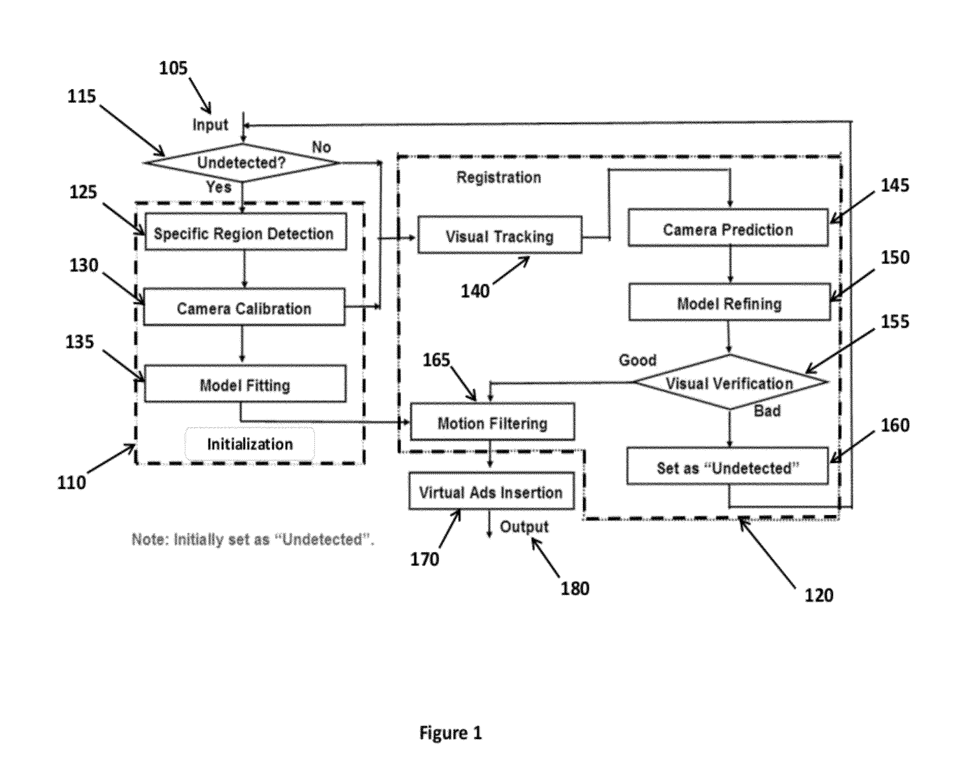

Turning now to FIG. 1, illustrated is a flow chart of a system for automatic insertion of an ad in a video stream, in accordance with an embodiment. Embodiments, as examples, provide techniques to find an insertion point for automatic insertion of an ad in a soccer, tennis, and street scene, and how to adapt a virtual ad to the real scene.

The system for automatic insertion of an ad in a video stream includes an initialization process 110 and a registration process 120. An input of a video sequence 105 such as of a tennis court is examined in block 115. If a scene of interest such as a tennis court is not detected in the video sequence, for example, a close-up of a player is being displayed which would not show the tennis court, the flow continues in the initialization process 110. In blocks 125, 130, and 135, a specific region such as a tennis court is attempted to be detected, the video camera is calibrated with the detected data, and a model such as a sequence of lines is fitted to the detected region, e.g., the lines of the tennis court are detected and modeled on the planar surface of the tennis court. Modeling the lines can include producing a best fit to known characteristics of the tennis court. The characteristics of the camera are determined such as its location with respect to the playfield, characteristics of its optics, and sufficient parameters so that a homography matrix can be constructed to enable camera image data to be mapped onto a model of the playfield. A homography matrix provides a linear transform that preserves perceived positions of observed objects when the point of view of an observer changes. Data produced by the camera calibration block 130 is transferred to the registration block 120, which is used for the initial and following frames of the video stream. The data can also be used in a later sequence of frames, such as a sequence of frames after a break for a commercial or an interview with a player. Thus, an image can be inserted a number of times in a sequence of frames.

In blocks 140, 145, and 150, the moving lines in the sequence of frames are tracked, and the homography matrix for mapping the scene of interest in the sequence of frames is updated. The model of the lines in the playfield is refined from data acquired from the several images in the sequence of frames.

In block 155, the model of lines is compared with data obtained from the current sequence of frames to determine if the scene that is being displayed corresponds, for example, to the tennis court, or if it is displaying something entirely different from the tennis court. If it is determined that the scene that is being displayed corresponds, e.g., to a playfield of interest, or that lines in the model correspond to lines in the scene, then a motion filtering algorithm is applied in block 165 to a sequence of frames stored in a buffer to remove jitter or other error characteristics such as noise to stabilize the resulting image, i.e., so that neither the input scene nor the inserted image will appear jittery. As indicated later hereinbelow, the motion filtering algorithm can be a simple low-pass filter or a filter that accounts for statistical characteristics of the data such as a least mean square filter. Finally, an image such as a virtual ad is inserted in the sequence of frames, as indicated in block 170, producing a sequence of frames containing the inserted image(s) as an output 180.

A soccer goalmouth example is described first in the context of ad insertion above a soccer goalmouth. A soccer goalmouth is assumed to be formed by two vertical and two horizontal white lines. White pixels are identified to find the lines. Because white pixels also appear on other areas such as player uniforms or advertisement logos, white pixels are constrained to be in the playfield only. Therefore, the playfield is extracted first through pre-learned playfield red-green-blue (“RGB”) encoded models. Then white pixels are extracted within the playfield, and straight lines are obtained by a Hough transform. The homography matrix/transform, described by Richard Hartley and Andrew Zisserman, in the book entitled “Multiple View Geometry in Computer Vision,” Cambridge University Press, 2003, which is hereby incorporated herein by reference, is determined from four-point correspondences of the goalmouth between their image positions and model positions. An advertisement is inserted into the position above the goalmouth bar by warping the image with the calculated homography matrix. In this manner, an ad is inserted above the goalmouth bar into the first frame.

For the following frames, the plane containing the goalmouth is tracked by an optical flow method as described by S. Beauchemin, J. Barron, in the paper entitled “The Computation of Optical Flow,” ACM Computing Surveys, 27(3), September 1995, which is hereby incorporated herein by reference, or by the key-point Kanade-Lucas-Tomasi (“KLT”) tracking method as described by J. Shi and C. Tomasi, in the paper entitled “Good Features to Track,” IEEE CVPR, 1994, pages 593-600, which is hereby incorporated herein by reference. The homography matrix/transform, which maps the current image coordinate system to the real goalmouth coordinate system, is updated from the tracking process. The playfield and white pixels are detected with the help of the estimated homography matrix. The homography matrix/transform is refined by fitting the lines with the goalmouth model. Then the inserted ad is updated with estimated camera motion parameters.

For a broadcast soccer video, there are always some frames showing players close-up, and some frames showing audiences, and even advertisements. These frames will be presently ignored to avoid inserting ads on false scenes and regions. If the playfield cannot be detected or if the detected lines cannot be fitted correctly with the goalmouth model, the frame will not be processed. In order to let the inserted ads persist for several frames (such as five), a buffer is set to store continuous frames and utilize a least mean square filter to remove high-frequency noise, and reduce jitter.

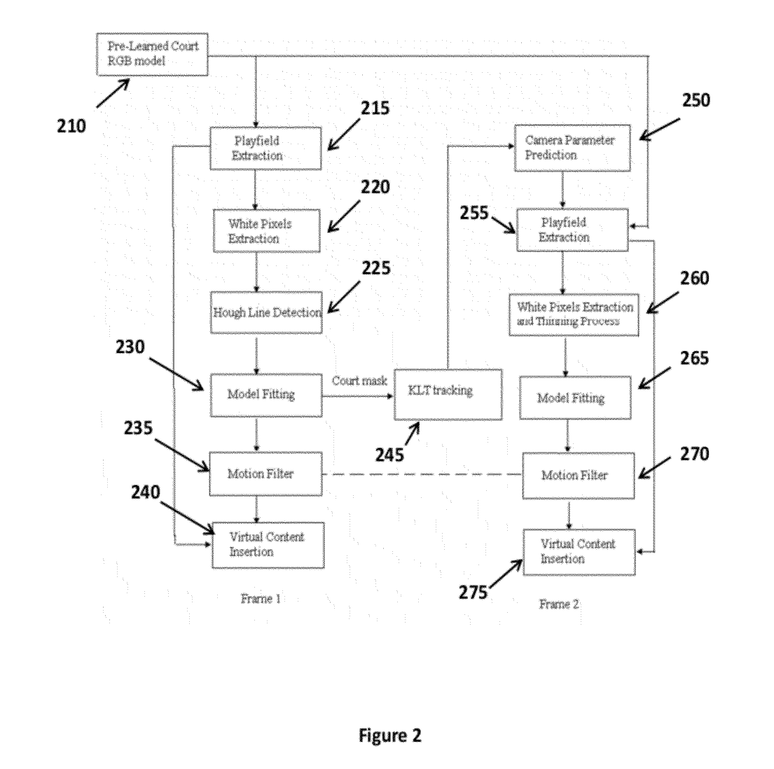

Turning now to FIG. 2, illustrated is a flowchart of the soccer goalmouth virtual content insertion system, in accordance with an embodiment. Block 210 represents the initialization block 110 described previously hereinabove with reference to FIG. 1. The vertical path on the left side of the figure following block 210 represents processes performed for a first frame, and the vertical path on the right side of the figure represents processes performed for a second and following frames.

Playfield extraction represented for a first frame by block 215 or for second and following frames by block 255 is now discussed. The first-order and second-order Gaussian RGB models are learned in advance by manually choosing the playfield region frame by frame in a training video. Assume the RGB value of a pixel (x, y) in an image I(x, y) is Vᵢ={Rᵢ, Gᵢ, Bᵢ} (i=1, 2, . . . widxhei). “Widxhei” is the product of image size in pixels. The mean and variance of the RGB pixels in the playfield are obtained by:

$$μ = \frac{1}{N} {\sum }_{i = 1}^{N} {V}_{i} , σ = \frac{1}{N} {\sum }_{i = 1}^{N} {( {V}_{i} - μ )}^{2} . \qquad ( 1 )$$

By comparing each pixel in a frame with the RGB models, the playfield/court mask can be obtained (in block 230 for a first frame or in block 265 for a second and following frames) by classifying with the binary value G(y) a pixel y with RGB value [r,g,b] in the frame

$$G ( y ) = \{ \begin{matrix}1 , & if \vert r - {μ}_{R} \vert < t {σ}_{R} AND \vert g - {μ}_{G} \vert < t {σ}_{G} AND \vert b - {μ}_{B} \vert < t {σ}_{B} \\ 0 , & otherwise ,\end{matrix}$$

where t is scaling factor (1.0<t<3.0), μ_{R}, μ_{G}, μ_{B}, are respectively the red, green, and blue playfield means, and σ_{R}, σ_{G}, σ_{B}, are respectively the red, green, and blue playfield standard deviations.

Although an ad is inserted above the goalmouth bar in this system, it is also possible to insert an ad in the penalty area on the ground since the binary image of white pixels in the penalty area has been obtained and, correspondingly, the lines that construct the penalty model.

Lines are detected by a Hough transform on these binary images, as represented by block 225. A Hough transform employs a voting procedure in a parameter space to select object candidates as local maxima in an accumulator space. Usually there will be close-by several lines detected in initial results, and the detection process is refined by non-maximal suppression.

Assume a line is parameterized by its normal \vec{n}=(nₓ,n_{y})^{T} with ∥\vec{n}∥=1 and the distance to the origin d. Candidate lines are classified as horizontal if |tan⁻¹(n_{y}/nₓ)|<25° and vertical, otherwise.

The homography matrix/transform, which maps the current image coordinate system to the real goalmouth coordinate system, is updated from the model fitting process, which may employ the KLT tracking method, as represented by block 245.

Camera calibration/camera parameter prediction and virtual content insertion is now discussed, as represented by block 250. The mapping from a planar region of the real world to the image as described by a homography transform H which is an eight-parameter perspective transformation, mapping a position p′ in the model coordinate system to an image coordinate p. These positions are presented in homogeneous coordinates, and the transformation p=Hp′ is rewritten as

$$( \begin{matrix}x \\ y \\ w\end{matrix} ) = ( \begin{matrix}{h}_{00} & {h}_{01} & {h}_{02} \\ {h}_{10} & {h}_{11} & {h}_{12} \\ {h}_{20} & {h}_{21} & {h}_{22}\end{matrix} ) ( \begin{matrix}{x}^{′} \\ {y}^{′} \\ {w}^{′}\end{matrix} ) \qquad ( 2 )$$

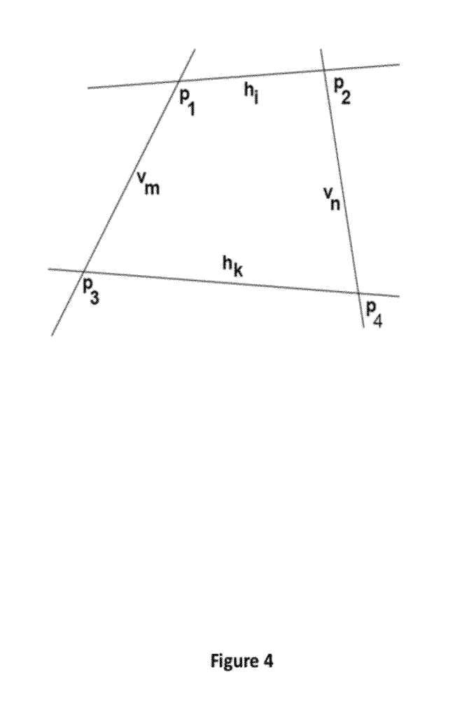

Homogeneous coordinates are scaling invariant, which reduces the degrees of freedom of H to only eight. Thus, there are four point-correspondences, which are enough to determine the eight parameters. Assuming two horizontal lines hᵢ, hⱼ and two vertical lines vₘ, vₙ (i=m=1, j=n=2), there are four resulting intersections which produce the points p₁, p₂, p₃, p₄ for the horizontal lines hᵢ and hₖ and the vertical lines vₘ and vₙ as illustrated in FIG. 4:

pₗ=hᵢ×vₘ,p₂=hᵢ×vₙ,p₃=hⱼ×vₘ,p₄=hⱼ×vₙ. (3)

The RANSAC (RANdom SAmple Consensus) method is applied, which is referred to by M. A. Fischler and R. C. Bolles, in the paper entitled “Random Sample Consensus: A Paradigm for Model Fitting with Applications to Image Analysis and Automated Cartography,”Comm. of the ACM 24: 381-395, 1981, which is hereby incorporated herein by reference, to obtain the homography matrix H through the four intersection points between the image and the corresponding model.

The image insertion position is chosen above the goalmouth bar, which height is predefined, such as one eighth of the goalmouth height. For a position P (x, y) in the inserted region, the corresponding position p′ in the model coordinate system is calculated by p′=H⁻¹p.

For feature tracking, the homography transform between neighboring frames is obtained by tracking feature points between the previous frame and the current frame. The optical flow method is one choice to realize this goal. Only points in the same plane as the goalmouth are chosen.

The motion filter represented by blocks 235 and 270 is now discussed. During line detection, homography calculation, and a back-projection process, there are inevitable noises that cause jittering in ad insertions. The high frequency noises are removed to improve performance. A low-pass filter is applied for the homography matrix to multiple (such as five) consecutive frames saved in the buffer.

A Wiener filter is applied for smoothing the inserted positions in the buffer. Assume the inserted patch's corner position pᵢ^{j}(j=1˜4) in the i^{th} frame is the linear combination of the previous N and following N frames.

$${p}_{i}^{j} = {\sum }_{k = - N}^{N} {α}_{i + k} {p}_{i + k}^{j} \qquad ( 1 )$$

The 2N+1 coefficients can be estimated from training samples. For example, if the number of the buffer is M, then the training samples are M−2N. If the 2N+1 neighbors for each sample are packed into a 1×(2N+1) row vector, then a data matrix C is obtained with size (M−2N)×(2N+1) and the sample vector \vec{p} with size (M−2N)×1. The optimal coefficients \vec{α} from the least squares (“LS”) formulation min ∥\vec{p}−C\vec{α}∥² has the closed-form solution given by:

\vec{α}=(C^{T}C)⁻¹C^{T}\vec{p} (2)

Then the estimated positions are obtained by equation (1). An estimated homography matrix can be obtained through camera calibration. A similar idea can be found in the paper by X. Li, entitled “Video Processing Via Implicit and Mixture Motion Models”, IEEE Trans. on CSVT, 17(8), pp. 953-963, August 2007, which is hereby incorporated herein by reference.

The virtual content is then inserted for a first frame in block 240 and for second and following frames in block 275.

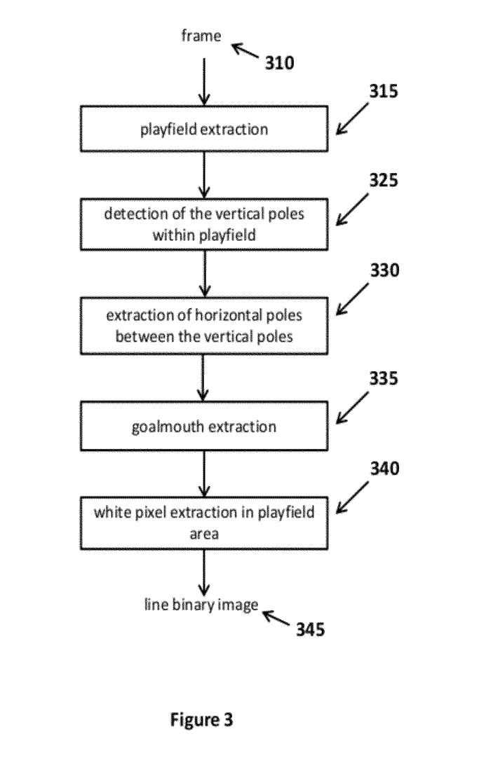

Line detection is now discussed further with reference to FIG. 3 that illustrates the goalmouth extraction procedure, in accordance with an embodiment. In response to an input frame 310 playfield extraction is performed in block 315, corresponding to the blocks 215 and 255 illustrated and described hereinabove with reference to FIG. 2. White pixels are obtained within the playfield, as represented by blocks 220 and 260, by setting an RGB threshold, e.g., to (200, 200, 200). Using the goalmouth extraction procedure illustrated in FIG. 3, the vertical poles in this playfield are detected first, as represented by block 325, and then the horizontal bar is detected between the vertical poles in the non-playfield region, as represented by block 330. Since horizontal lines should have similar directions, the white lines in the playfield parallel to the horizontal bar intersecting the two vertical poles are found. Finally the white pixel masks of both the goalmouth and the playground are obtained, as represented by blocks 335 and 340. The result is a line binary image, 345.

A second example is now described in the context of ad insertion in a tennis court.

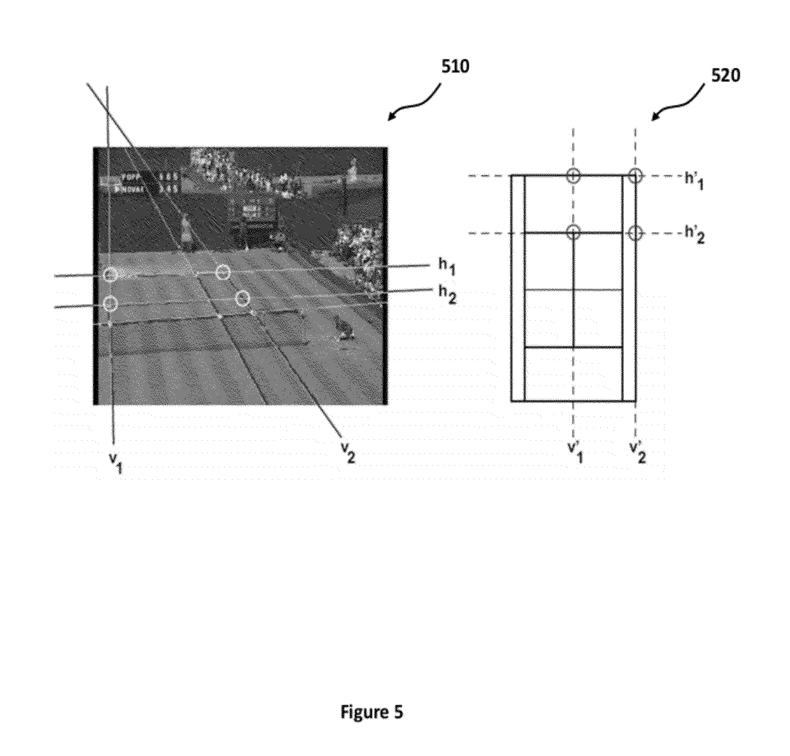

Turning now to FIG. 5, illustrated are the ten lines corresponding to an image 510 and a corresponding tennis court model 520, in accordance with an embodiment. A tennis court is regarded as a planar surface described by five horizontal white lines, two examples of which are h₁, h₂, in the image corresponding to h′₁, and h′₂ in the model, and five vertical white lines, two examples of which are v₁, v₂, in the image corresponding to v′₁, and v′₂ in the model. In the case of a tennis court, the horizontal direction refers to top-bottom lines in the plane of the tennis court parallel to the net. The vertical direction refers to lines from left to right in the plane of the tennis court normal to the net. Although some intersections of lines do not exist in the real world, these virtual intersection points of the tennis court model are used in constructing the homography transformation in a robust framework.

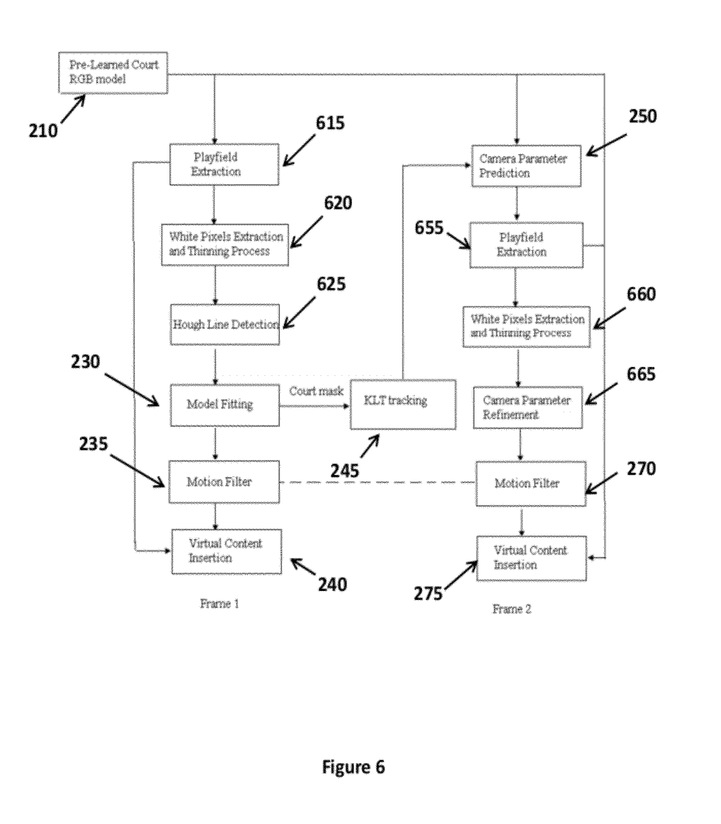

Turning now to FIG. 6, illustrated is a flowchart of the tennis court ad insertion process, in accordance with an embodiment. The vertical path on the left side of the figure following block 210 represents processes performed for a first frame, and the vertical path on the right side of the figure represents processes performed for a second and following frames. The process of ad insertion in a tennis court contains elements similar to those illustrated and described with reference to FIG. 2 for a soccer goalmouth; similar elements will not be redescribed in the interest of brevity. However, since there are more lines in a tennis scene, it is more complex to detect these lines and find the best homography transformation among several combinations of horizontal and vertical line.

A camera parameter refinement process 665 is used in a tennis court ad insertion system in place of the model fitting block 265 illustrated and described hereinabove with reference to FIG. 2. The detailed processes of line detection and model fitting are also different from those employed for soccer scenarios. With the best combination of lines, the same procedure is applied to calculate the homography matrix with the corresponding four intersection points. Then virtual content is inserted within a chosen region. The KLT feature tracking method is used to estimate camera parameters and then refine the playfield and line detection. Details of each module are described further below.

Playfield extraction in blocks 615 and 655 for a tennis court is described first. There are four typical tennis courts from different grand-slam tournaments, namely, US Open, French Open, Australian Open, and Wimbledon tournaments. For U.S. Open and Australian Open tournaments, there are two different colors in the inner and outer parts of the court. For these two cases, the Gaussian RGB models are “learned” for both parts.

Prior to line detection in block 625, the binary image of white pixels is obtained in blocks 620 and 660 by comparing the pixel values with the RGB threshold (140, 140, 140) within the court region. These white pixels are thinned to reduce the error in line detection in block 625 by a Hough transform. However, the initial results generally contain too many lines close-by, and these are refined and discarded by non-maximal suppression.

Define the set L as a line candidate which contains white pixels close to it. A more robust line parameter (nₓ, n_{y}, −d) is obtained by solving the least mean square (“LMS”) problem as below to produce the line parameters (nx, ny, −d).

$$\begin{matrix}L = \{ p = {( x , y )}^{T} \vert l ( x , y ) = {1}^{⋀} \vert ( {n}_{x} {n}_{y} - d ) \cdot p \vert < {σ}_{r} \} & ( 5 ) \\ ( \begin{matrix}{x}_{1} & {y}_{1} \\ {x}_{2} & {y}_{2} \\ {x}_{3} & y \\ ⋮ & ⋮ \\ {x}_{L} & {y}_{L}\end{matrix} ) ( \begin{matrix}{m}_{x} \\ {m}_{y}\end{matrix} ) = ( \begin{matrix}\begin{matrix}\begin{matrix}\begin{matrix}1 \\ 1\end{matrix} \\ 1\end{matrix} \\ 1\end{matrix} \\ 1\end{matrix} ) & \\ d := \frac{1}{\sqrt{{m}_{x}^{2} + {m}_{y}^{2}}} , {n}_{x} := {m}_{x} d , {n}_{y} := {m}_{y} d . & \end{matrix}$$

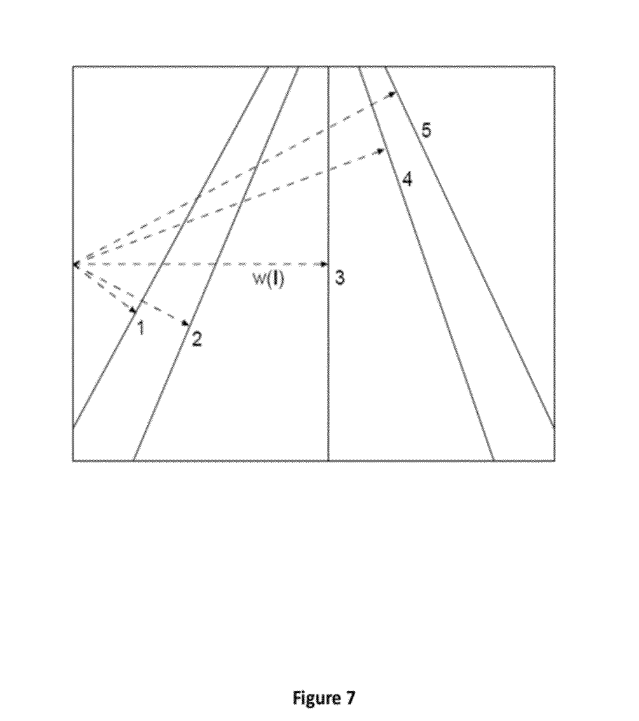

Candidate lines are classified into horizontal and vertical line sets. Moreover, the set of vertical lines are ordered from left to right, and the set of horizontal lines from top to bottom. The lines are sorted according to their distance from a point on the left border or on the top border. FIG. 7 shows an example of sorting vertical lines from left to right, numbered 1, 2, 3, 4, 5, to produce an ordered set, in accordance with an embodiment.

For model fitting, C_{H} horizontal line candidates and Cᵥ vertical candidates are assumed. The number of possible input combinations of lines is C_{H}Cᵥ(C_{H}−1)(Cᵥ−1)/4. Two lines are chosen from each line set and then a guessed homography matrix H is obtained by mapping four intersection points to the model. Among all the combinations of lines, one combination is found to fit the model court best.

The evaluation process transforms all line segments of the model to image coordinates according to the guessed homography matrix H by the equation pᵢ=Hp′ᵢ. Each intersection of model lines p′ᵢp′₂ is transformed into the image coordinates p₁p₂. The line segment between the image coordinates p₁p₂ is sampled at discrete positions along the line and an evaluation value is increased by 1.0 if the pixel is a white court line candidate pixel, or decreased by 0.5 if it is not. Pixels outside the image are not considered. Eventually each parameter set is rated by computing its score as:

$${\sum }_{{p}_{1} {p}_{2}} {\sum }_{( x , y )} \{ \begin{matrix}1 , l ( x , y ) = 1 \\ - 0.5 , l ( x , y ) = 0 \\ 0 , ( x , y ) outside .\end{matrix} \qquad ( 6 )$$

After all calibration matrices have been evaluated, the matrix with the largest matching score is selected as the best calibration parameter setting. For consecutive frames, the homography matrix using the KLT feature tracking result is estimated. The evaluation process will be much simpler and the best matching score needs to be searched within a small number of combinations because the estimated homography matrix constrains the possible line positions.

For color harmonization, the virtual content is inserted in the same way as for the soccer goalmouth. Since the ad will be inserted on the court, it is better to make its color harmonious with the playground so that viewers are not disturbed. Details about color harmonization are found in the paper by C. Chang, K. Hsieh, M. Chiang, J. Wu, entitled “Virtual Spotlighted Advertising for Tennis Videos,” J. of Visual Communication and Image Representation, 21(7):595-612, 2010, which is hereby incorporated herein by reference.

Let I(x, y), I_{Ad}(x, y) and I′(x, y) be respectively the original image value, ad value, and the actual inserted value at pixel (x, y). The court mask is I_{M}(x, y), which is 1 if (x, y) is in the court region φ and 0 if not. Then the court mask and the actual inserted value are found from the equations:

$$\begin{matrix}{I}_{M} ( x , y ) = \{ \begin{matrix}0 & ( x , y ) ∈ φ \\ 1 , & otherwise ,\end{matrix} & ( 7 ) \\ {I}^{′} ( x , y ) = ( 1 - α {I}_{M} ( x , y ) ) I ( x , y ) + α {I}_{M} ( x , y ) {I}_{Ad} ( x , y ) . & \end{matrix}$$

Based on a contrast sensitivity function, parameter α (normalized opacity) is estimated by:

$$\begin{matrix}α = A exp ( {f}_{0} \cdot f \cdot \frac{- {\hat{θ}}_{e} ( p , {p}_{f } )}{{θ}_{0}} ) , α ∈ [ 0 , 1 ] & ( 8 ) \\ {\hat{θ}}_{e} ( p , {p}_{f } ) = max [ 0 , {θ}_{e} ( p , {p}_{f} ) - {θ}_{f} ] , & \\ {θ}_{e} ( p , {p}_{f} ) = {tan}^{- 1} ( \frac{‖ p - {p}_{f} ‖}{{D}_{v}} ) , & \end{matrix}$$

where A is the amplitude tuner, f₀ is the spatial frequency decay constant (in degrees), f is the spatial frequency of the contrast sensitivity function (cycles per degree), \hat{θ}ₑ(p, p_{f}) is the general eccentricity (in degrees), θₑ(p, p_{f}) is the eccentricity, p is the given point in the image, p_{f} is the fixation point (for example, the player in the tennis match), θ₀ is the half resolution eccentricity constant, θ_{f} is the full resolution eccentricity (in degrees), and Dᵥ is the viewing distance in pixels. The following values are used in these examples. A=0.8, f₀=0.106, f=8, θ_{f}=0.5°, and θ₀=2.3°. The viewing distance Dᵥ is approximated as 2.6 times the image width in the video.

A third example is now described with respect to ad insertion on a building façade.

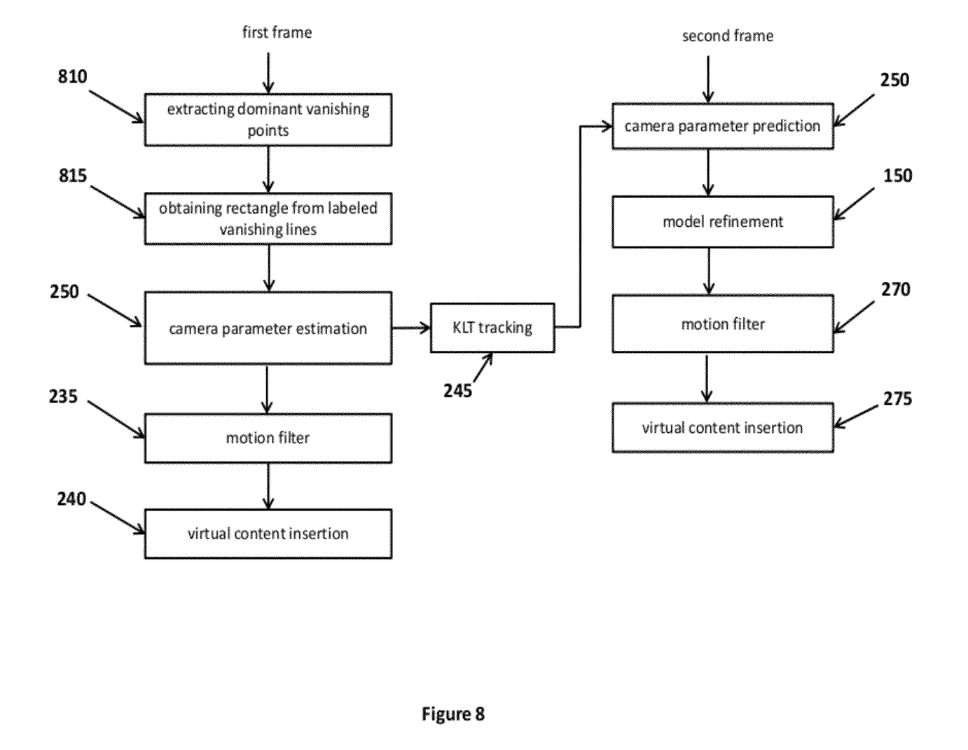

Turning now to FIG. 8, illustrated is a flowchart for insertion of an ad in a building façade, in accordance with an embodiment. In FIG. 8 is assumed that a pre-learned court RGB model, such as the RGB model 210 described with reference to FIGS. 2 and 6, has already been performed. The vertical path on the left side of the figure represents processes performed for a first frame, and the vertical path on the right side of the figure represents processes performed for a second and following frames. Details of each module are described below.

A modern building façade is regarded as planar and suitable for inserting virtual content. However, due to the large variability in building orientations, it is more difficult to insert ads than in sport scenarios. Ad insertion on a building façade extracts vanishing points first and then labels lines associated with corresponding vanishing points. Similar to tennis and soccer cases, two lines from a horizontal and vertical line set are combined to calculate a homography matrix which maps the real-world coordinate system to the image coordinate system. However, there are usually many more lines in a building façade, and every combination cannot be enumerated practically as in the tennis case. In block 810, dominant vanishing points are extracted. In block 815, the largest rectangle in the façade is attempted to be obtained that is able to pass both corner verification and dominant direction verification. Then the virtual content can be inserted in the largest rectangle.

In consecutive frames, the KLT feature tracking method pursues the corner feature points from which the homography matrix is estimated. In order to avoid jitter, in block 235 a buffer is used to store the latest several (five, for instance) frames, and apply a low-pass filter or a Kalman filter to smooth the homography matrices.

For extracting the dominant vanishing points in block 810, the vanishing points are detected first to get prior knowledge about the geometric properties of the building façade. A non-iterative approach is used as described by J. Tardif, in the paper entitled “Non-Iterative Approach for Fast and Accurate Vanishing Point Detection,” IEEE ICCV, pp. 1250-1257, 2009, which is hereby incorporated herein by reference with a slight modification. This method avoids representing edges on a Gaussian sphere. Instead, it directly labels the edges.

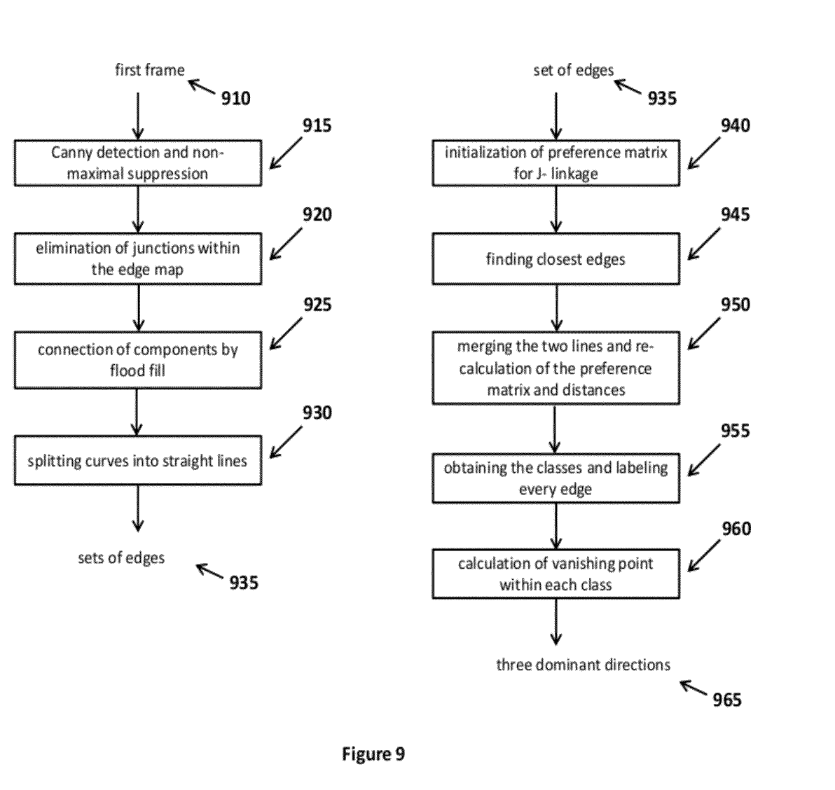

Turning now to FIG. 9, illustrated is a flowchart for detecting vanishing points associated with a building façade, in accordance with an embodiment.

The algorithm starts for a first frame 910 from obtaining a parsed set of edges by Canny detection in block 915. The input is a grey-scale or color image and the output is a binary image, i.e., a black and white image. White points denote edges. This is followed by non-maximal suppression to obtain a map of one pixel-thick edges. Then junctions are eliminated (block 920) and connected components are linked using flood-fill (block 925). Each component (which may be represented by curved lines) is then divided into straight edges by browsing a list of coordinates. It will split when the standard deviation of fitting a line is larger than a one pixel. Separate short segments that lie on the same line are also merged to reduce error and also to reduce computation complexity in classifying lines.

The notations to present the straight lines are listed in Table 1, below. Besides, a function, denoted D(v, εⱼ), provides a measure of the consistency between a vanishing point v and an edge εⱼ given in closed form by the equation:

D(v,εⱼ)=dist(eⱼ¹,\vec{l}), where \vec{l}=[\vec{e}ⱼ]ₓv. (9)

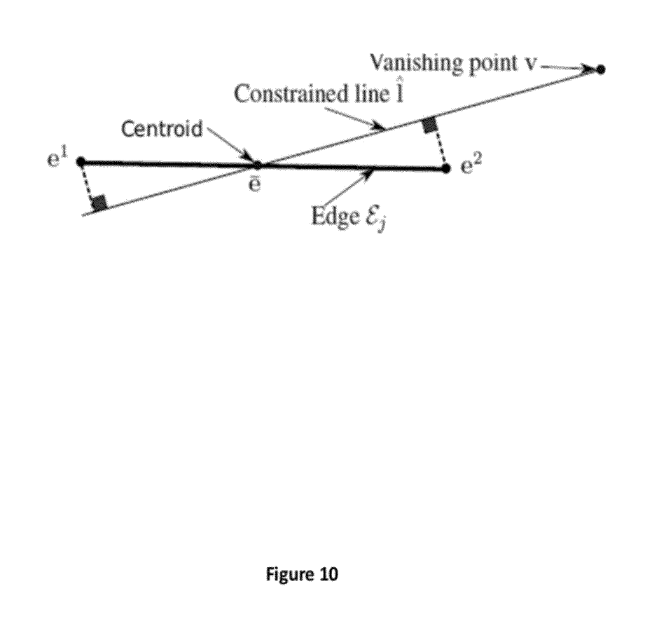

The orthogonal distance of a point p and a line l (as illustrated in FIG. 10, showing estimation of a constrained line, in accordance with an embodiment) is defined as

$$dist ( l , p ) = \frac{\vert {l}^{T} p \vert}{\sqrt{{l}_{1}^{2} + {l}_{2}^{2}}} . \qquad ( 10 )$$

TABLE 1
DEFINITION OF DETECTED EDGES

| Entities | Definition |
|---|---|
| εₙ | Edge indexed n |
| eₙ¹, eₙ² | The two end points of εₙ, ε [symbol] ² |
| eₙ | Centroid of the end points, ε [symbol] ² |
| Iₙ | Implicit line passing by εₙ, ε [symbol] ² |
| Sₘ | Subset of edges of ε |
| \|Sₘ\| | Size of the set Sₘ |

Another function, denoted as V(S,w), where w is a vector of weights, computes a vanishing point using a set of edges S.

A set of N edges 935 is input and a set of vanishing points is obtained as well as edge classifications, i.e., assigned to a vanishing point or marked as an outlier. The solution relies on the J-Linkage algorithm, initialized in block 940, to perform the classification.

A brief overview of the J-Linkage algorithm in the context of vanishing point detection is given as follows. In the J-Linkage algorithm, the parameters are the consensus threshold φ and the number of vanishing point hypotheses M (φ=2 pixel, M=500, for example).

The first step is to randomly choose M minimal sample sets of two edges S₁, S₂, . . . , S_{M} and to compute a vanishing point hypothesis vₘ=V(Sₘ, \vec{1}) for each of them (\vec{1} is a vector of ones, i.e., the weights are equal). The second step is to construct the preference matrix P, an N×M Boolean matrix. Each row corresponds to an edge εₙ and each column to a hypothesis vₘ. The consensus set of each hypothesis is computed and copied to the m^{th} column of P. Each row of P is called the characteristic function of the preference set of the edge εₙ: P(n, m)=1 if vₘ, and εₙ are consistent, i.e., when D(v, εₙ)≦φ, and 0 otherwise.

The J-Linkage algorithm is based on the assumption that edges corresponding to the same vanishing point tend to have similar preference sets. Indeed, any non-degenerate choice of two edges corresponding to the same vanishing point should yield solutions with similar, if not identical, consensus sets. The algorithm represents the edges by their preference set and clusters them as described further below.

The preference set of a cluster of edges is defined as the intersection of the preference sets of its members. It uses the Jaccard distance between two clusters by:

$${d}_{j} ( A , B ) = \frac{\vert A ⋃ B \vert - \vert A ⋂ B \vert}{\vert A ⋃ B \vert} . \qquad ( 11 )$$

where A and B are the preference sets of each of them. It equals 0 if the sets are identical and 1 if they are disjoint. The algorithm proceeds by placing each edge in its own cluster. At each iteration, the two clusters with minimal Jaccard distance are merged together (block 945). The operation is repeated until the Jaccard distance between all clusters is equal to 1. Typically, between 3 and 7 clusters are obtained. Once clusters of edges are formed, a vanishing point is computed for each of them. Outlier edges appear in very small clusters, typically of two edges. If no refinement is performed, small clusters are classified as outliers.

The vanishing points for each cluster are re-computed (block 950) and refined using the statistical expectation—maximization (“EM”) algorithm. An optimal problem is written as:

$$\hat{v} = arg {min}_{v} {\sum }_{{ɛ}_{j} ∈ S}^{ } {w}_{j}^{2} {dist}^{2} ( {[ {\overline{e}}_{j} ]}_{x} v , {e}_{j}^{1} ) , \qquad ( 12 )$$

which is solved by the Lvenberg-Marquardt minimization algorithm described by W. H. Press, B. P. Flannery, S. A. Teukolsky, W. T. Vetterling, in the book entitled “Numerical Recipes in C,” Cambridge University Press, 1988, which is hereby incorporated herein by reference. Now the definition of function V(S, w) by

$$V ( S , w ) = \{ \begin{matrix}{l}_{1} {xl}_{2} & if S contains 2 edges \\ \hat{v} & otherwise\end{matrix}$$

is clear.

For rectangle detection, two line sets are obtained corresponding to two different dominant vanishing points. Similarly, the homography matrix is estimated through two horizontal and vertical lines. However, there are many short lines and segments lying on the same line are merged, and lines that are either close-by or too short are suppressed. Moreover, both the line candidates are sorted from left to right or from top to bottom.

For each combination of two line sets, a rectangle is formed, but not every one lies on the façade of building. Two observation truths are used to test these rectangle hypotheses. One is the four intersections are actual corners of the building, which deletes the case of intersections of lines in the sky. Another is the front view of this image patch contains horizontal and vertical directions. The gradient histogram is used to find the dominant directions of the front-view patch. An ad is inserted on the largest rectangle that passes the two tests.

These latter steps are represented by blocks 950, 955, and 960 to produce three dominant directions, 965.

There are many corners in the building façade; therefore, it is suitable to use the KLT feature-tracking method.

Embodiments have thus been described for three examples. It is understood, however, that the concepts can be applied to additional areas.

As discussed above, embodiments determine where and when to insert ads, and how to immerse ads into a real scene without jittering and misalignment in soccer, tennis, and street views, as examples. Various embodiments provide a closed-loop combination of tracking and detection for virtual-real scene registration. Automatic detection of a specific region for insertion of ads is disclosed.

Embodiments have a number of features and advantages. These include:

(1), line detection from an extracted image, while pixels only on the playfield are masked for soccer and tennis videos,

(2), closed-loop detection and tracking for camera estimation (homography), where the tracking method is either optical flow or keypoint-based, and detection is refined by prediction from tracking,

(3), motion filtering after virtual-real registration to avoid flicking, and

(4), automatic insertion of ads into a building façade scene of street videos.

Embodiments can be used in a content delivery network (“CDN”), e.g., in a system of computers on the Internet that transparently delivers content to end users. Other embodiments can be used with cable TV, Internet Protocol television (“IPTV”), and mobile TV, as examples. For example, embodiments can be used for a video ad server, clickable video, and targeted mobile advertising.

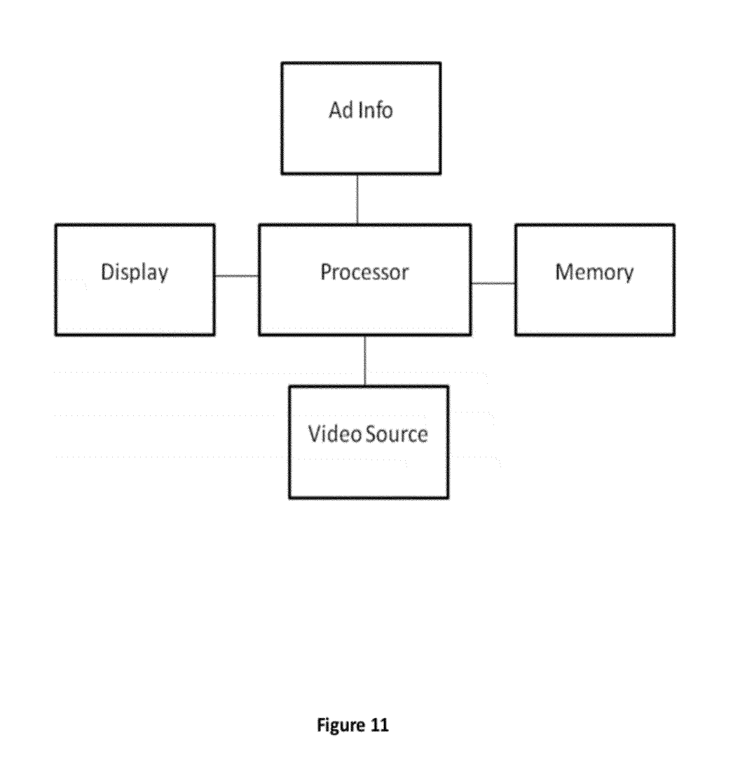

FIG. 11 illustrates a processing system that can be utilized to implement embodiments of the present invention. This illustration shows only one example of a number of possible configurations. In this case, the main processing is performed in a processor, which can be a microprocessor, a digital signal processor, an application-specific integrated circuit (“ASIC”), dedicated circuitry, or any other appropriate processing device, or combination thereof. Program code (e.g., code implementing the algorithms disclosed above) and data can be stored in a memory or any other non-transitory storage medium. The memory can be local memory such as dynamic random access memory (“DRAM”) or mass storage such as a hard drive, solid-state drive (“SSD”), non-volatile random-access memory (“NVRAM”), optical drive or other storage (which may be local or remote). While the memory is illustrated functionally with a single block, it is understood that one or more hardware blocks can be used to implement this function.

The processor can be used to implement various steps in executing a method as described herein. For example, the processor can serve as a specific functional unit at different times to implement the subtasks involved in performing the techniques of the present invention. Alternatively, different hardware blocks (e.g., the same as or different than the processor) can be used to perform different functions. In other embodiments, some subtasks are performed by the processor while others are performed using a separate circuitry.

FIG. 11 also illustrates a video source and an ad information source. These blocks signify the source of video and the material to be added as described herein. After the video has been modified it can be sent to a display, either through a network or locally. In a system, the various elements can all be located in remote locations or various ones can be local relative to each other. Embodiments such as those presented herein provide a system and a method for inserting a virtual image into a sequence of video frames. For example, embodiments such as those disclosed herein provide an apparatus to insert a virtual image into a sequence of video frames, the apparatus including a processor configured to capture geometric characteristics of the sequence of video frames, employ the captured geometric characteristics to define an area of the video frames for insertion of a virtual image, register a video camera to the captured geometric characteristics, identify features in the sequence of video frames to identify the defined area of video frames for insertion of the virtual image, and insert the virtual image into the defined area. The apparatus further includes a memory coupled to the processor, and configured to store the sequence of video frames and the virtual image inserted into the defined area.

In an embodiment, vanishing points are estimated to determine the geometric characteristics. Two groups of parallel lines can be employed to identify the defined area. In an embodiment, white pixels above an RGB threshold level are employed to capture the geometric characteristics. Parallel lines corresponding to vertical and horizontal directions in the real world can be employed for registering the video camera. In an embodiment, the virtual image is blended with the area of video frames prior to inserting the virtual image in the defined area. In an embodiment, a homography matrix is employed to identify features in the sequence of video frames. In an embodiment, inserting the virtual image in the defined area includes updating the virtual image with estimated camera motion parameters. In an embodiment, capturing geometric characteristics of the sequence of video frames includes applying A Hough transform can be applied to white pixels extracted from the sequence of video frames to capture geometric characteristics of the sequence of video frames. In an embodiment, capturing geometric characteristics of the sequence of video frames includes extracting vanishing points of detected lines.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

We claim:

1. A method for inserting a virtual image into a sequence of video frames, the method comprising:
capturing geometric characteristics of the sequence of video frames;
employing the captured geometric characteristics to define an area of the video frames for insertion of a virtual image;
identifying features in the sequence of video frames to identify the defined area of video frames for insertion of the virtual image; and
inserting the virtual image in the defined area.

2. The method as recited in claim 1, further comprising registering a video camera to the captured geometric characteristics.

3. The method as recited in claim 1 wherein vanishing points are estimated to determine the geometric characteristics.

4. The method as recited in claim 1 wherein two groups of parallel lines are employed to identify the defined area.

5. The method as recited in claim 1 wherein white pixels above an RGB threshold level are employed to capture the geometric characteristics.

6. The method as recited in claim 1 wherein parallel lines corresponding to vertical and horizontal directions in the real world are employed for registering the video camera.

7. The method as recited in claim 1 wherein the virtual image is blended with the area of video frames prior to inserting the virtual image in the defined area.

8. The method as recited in claim 1 wherein a homography matrix is employed to identify features in the sequence of video frames.

9. The method as recited in claim 1 wherein inserting the virtual image in the defined area includes updating the virtual image with estimated camera motion parameters.

10. The method as recited in claim 1 wherein capturing geometric characteristics of the sequence of video frames includes applying a Hough transform to white pixels are extracted from the sequence of video frames.

11. The method as recited in claim 1 wherein capturing geometric characteristics of the sequence of video frames includes extracting vanishing points of detected lines.

12. An apparatus to insert a virtual image into a sequence of video frames, the apparatus comprising:
a processor configured to
capture geometric characteristics of the sequence of video frames,
employ the captured geometric characteristics to define an area of the video frames for insertion of a virtual image,
register a video camera to the captured geometric characteristics,
identify features in the sequence of video frames to identify the defined area of video frames for insertion of the virtual image, and
insert the virtual image into the defined area; and
a memory coupled to the processor, the memory configured to store the sequence of video frames and the virtual image inserted into the defined area.

13. The apparatus as recited in claim 12 wherein vanishing points are estimated to determine the geometric characteristics.

14. The apparatus as recited in claim 12 wherein two groups of parallel lines are employed to identify the defined area.

15. The apparatus as recited in claim 12 wherein white pixels above an RGB threshold level are employed to capture the geometric characteristics.

16. The apparatus as recited in claim 12 wherein parallel lines corresponding to vertical and horizontal directions in the real world are employed for registering the video camera.

17. The apparatus as recited in claim 12 wherein the virtual image is blended with the area of video frames prior to inserting the virtual image in the defined area.

18. The apparatus as recited in claim 12 wherein a homography matrix is employed to identify features in the sequence of video frames.

19. The apparatus as recited in claim 12 wherein inserting the virtual image in the defined area includes updating the virtual image with estimated camera motion parameter.

20. The apparatus as recited in claim 12 wherein capturing geometric characteristics of the sequence of video frames includes applying a Hough transform to white pixels are extracted from the sequence of video frame.

21. The apparatus as recited in claim 12 wherein a homography matrix is employed to identify features in the sequence of video frames.
